(19) United States
(12) Patent Application Publication
(10) Pub. No.: US 2019/0122164 A1
(43) Pub. Date: Apr. 25, 2019

(54) ON-DEMAND COORDINATED COMESTIBLE ITEM DELIVERY SYSTEM

(71) Applicant: Uber Technologies, Inc., San Francisco, CA (US)

(72) Inventors: Nathan Berrebbi, San Francisco, CA (US); Ferras Hamad, San Francisco, CA (US); Isaac Liu, San Francisco, CA (US); Thanh Le Nguyen, Sunnyvale, CA (US); Xian Xing Zhang, San Francisco, CA (US); Yuanxuan Wang, San Francisco, CA (US); Yuyan Wang, San Francisco, CA (US); Yuanchi Ning, San Francisco, CA (US)

(21) Appl. No.: 16/059,483

(22) Filed: Aug. 9, 2018

Related U.S. Application Data
(60) Provisional application No. 62/576,621, filed on Oct. 24, 2017.

(51) Int. Cl. G06Q 10/08; G06Q 30/06

(52) U.S. Cl. CPC G06Q 10/083; G06Q 30/0643; G06Q 30/0631

(57) ABSTRACT

A system can implement an on-demand delivery service for available menu items by generate menu item vectors representing menu items and personal preference vectors representing user preferences in latent space comprising a word corpus of descriptive terms. Based on these vectors or matrices, the system can determine a set of matching menu items for the user, and transmit content data to a computing device of the user, causing the computing device to display the set of matching menu items as recommended selectable items for on-demand delivery. Based on a user selection of one of the available menu items, the system can coordinate on-demand delivery of the selected menu item to the respective user.

### CROSS REFERENCE TO RELATED APPLICATION

This application claims the benefit of priority to U.S. Provisional Application No. 62/576,621, titled “Food Item Recommendation Service for On-Demand Coordinated Food Delivery System,” filed on Oct. 24, 2017; which is hereby incorporated by reference in its entirety.

### BACKGROUND

On-demand food delivery requires requesting users to request a menu item from menu listings of individual restaurants. The requests are processed by the restaurants themselves, which can either deliver the requested item after preparation, or the requesting user can coordinate with a third party to pick up the requesting item for personalized delivery.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network computer system implementing comestible goods recommendation and on-demand coordinated delivery, in accordance with examples described herein;

FIG. 2 is a block diagram illustrating an example user computing device executing a service application for communicating with a network computer system, according to examples described herein;

FIGS. 3A and 3B illustrate example user interfaces listing menu item recommendations, according to examples described herein;

FIGS. 4A and 4B illustrate example user interfaces showing real-time and on-demand comestible item listings, according to examples described herein;

FIG. 5 is a block diagram illustrating an example source computing device executing and operating a source application for communicating with a network computer system, according to examples described herein;

FIGS. 6A and 6B illustrate example source interfaces for menu item sources, according to examples described herein;

FIG. 7 is a flow chart describing an example method of coordinating menu item delivery based on generated item recommendations for users of an on-demand item delivery service, according to various examples;

FIG. 8 is a flow chart describing a method of coordinating menu item delivery using multi-entity optimization, according to various examples; and

FIG. 9 is a block diagram that illustrates a computer system upon which examples described herein may be implemented.

### DETAILED DESCRIPTION

An on-demand delivery service (e.g., an on-demand food delivery service) can be managed by a network-based computing system by connecting requesting users, delivery drivers, and comestible item sources (e.g., restaurants) via designated applications specific to the on-demand delivery service. The network computer system can coordinate on-demand menu item delivery by providing a service application to requesting users that lists a set of available menu items from various food item sources throughout a given region. In various examples, the network computer system acts as a logistical optimizer that preempts menu item demand by coordinating delivery of pre-prepared food items in delivery vehicles and transporting the items to requesters on-demand in response to received item requests. In doing so, the network computer system can implement deep learning techniques to forecast item demand for individual food items (e.g., based on historical data and a variety of other factors, such as weather, time of week, time of day, etc.), provide real-time recommendations based on contextual user information (e.g., search inputs, location, historical preferences), and additional real-time demand optimization techniques to meet source supply from food item sources.

According to various examples, the network computer system can receive representations of a set of available food items (e.g., basic menu descriptions with an image of the food item) from various participating sources (e.g., restaurants). The network computer system can perform image analysis techniques (e.g., image or pattern recognition using convolutional neural network methods) on the images of food items, and extract a textual representation of the food item. It is contemplated that the textual extraction from the image analysis operation can be significantly more detailed than any basic description provided by the restaurant. Accordingly, the broader textual extraction from the image can be leveraged to generate a more personalized menu for users of the on-demand coordinated food delivery service.

In certain implementations, the textual extraction (e.g., a corpus of words comprising a detailed word representation of the food item as shown in the image) can be represented in vector form by the network computer system. For example, the network computer system can generate a word vector based on the textual extraction, where the word vector ultimately represents the food item. Accordingly, for a full menu of food items, the network computer system can generate a set of word vector representations for each menu item.

On the user side, the network computer system can generate a user profile for each user of the on-demand coordinated delivery system. The user profile can indicate the user's menu item preferences. In various implementations, the user preferences can be determined via direct query and/or learned from historical data. For example, the network computer system can collect, store, and analyze user interaction, selections, and behaviors in connection with the on-demand delivery service. For example, the selections may indicate that the user has a specific preference for Indian food, Thai food, or a general preference for spicy food. In certain examples, the network computer system can generate a highly detailed user preference profile for each user using deep learning techniques based on the user's activities, selections, views, content preferences, demographics, age, location, cultural background, and the like.

According to various embodiments, the user preferences of a respective user can be represented in vector form (e.g., indicating preferred ingredients, food characteristics, food restrictions, food type, origin, price, quality, and the like). At any given triggering instant (e.g., when the user initiates the service application), the network computer system can perform a vector or matrix factorization between the personal preference vector representing the user's personal preferences and each of the food item vectors representing the full menu of food items (e.g., items that are available at the time of the triggering instant). As described herein, the results of the factorization can comprise a match probability for the user, which the network computer system can generate as a menu item recommendation on the user interface of the on-demand delivery service, executed on the user's computing device.

Upon selection of a food item from the menu, the network computer system can coordinate the delivery of the selected food item by transmitting a delivery invitation to a driver that possesses an inventory of the selected food item. For example, the computer system can track the inventories and locations of each transport vehicle operating throughout a delivery service region (e.g., a metropolitan area), and select an optimal transport vehicle (e.g., based on distance, time, or other utility metrics) to rendezvous with the user and deliver the selected item.

Among other benefits, examples described herein achieve a technical effect of implementing deep learning and computational optimization techniques to provide both users and comestible item sources of an on-demand comestible item delivery service with more efficient and robust services. For example, the on-demand comestible item service can provide users with more personalized recommendations and or a personalized menu of comestible items based on the user's personal preferences, and further based on real-time contextual information received from the user's computing device (e.g., via an executing service application), real-time data from the comestible goods sources, and/or the real-time locations of delivery drivers, each of which can transport an inventory of comestible goods from one or multiple sources.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method.

Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

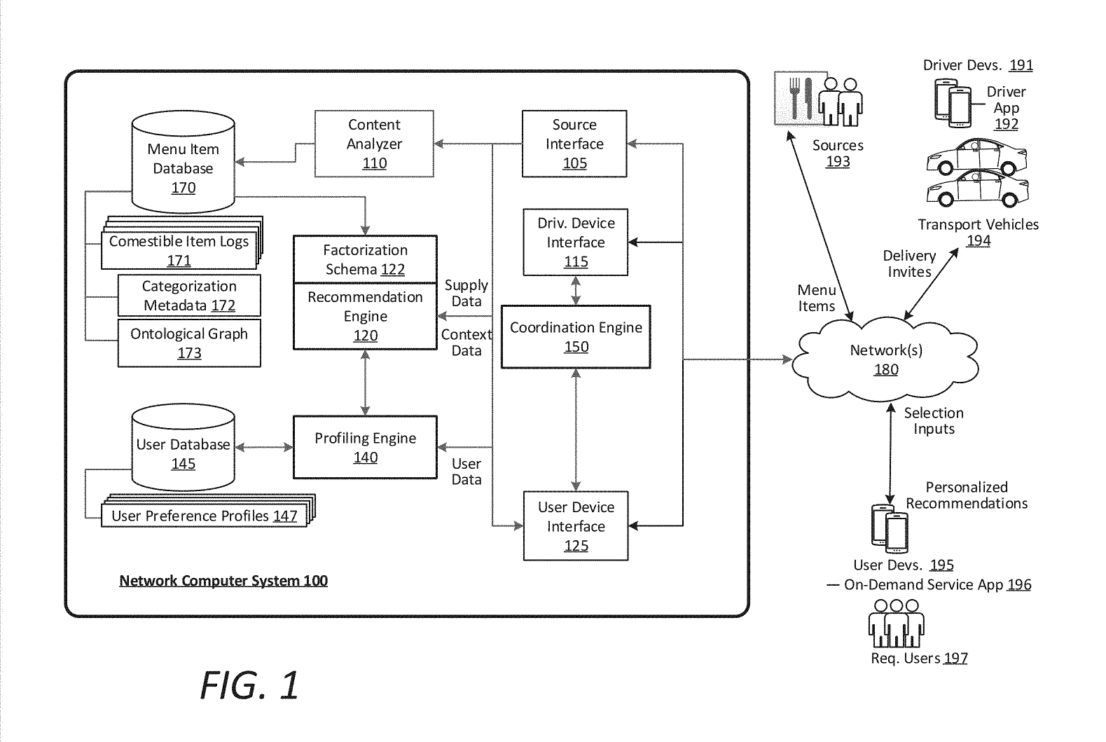

FIG. 1 is a block diagram illustrating an example network computer system implementing comestible goods recommendations and on-demand coordinated delivery, in accordance with examples described herein. The network computer system 100 can include a menu item database 170 that comprises food logs 171 representing various menu items submitted by menu item sources 193, and/or a categorization schema 172 that categorizes menu items (e.g., food items) into a set of descriptive words (e.g., in metadata). For example, at any given time or in accordance with a set schedule, each participating source 193 (e.g., a restaurant) can connect with the network computer system 100 over one or more networks 180 via a source interface 105 to provide the offered menu items for coordinated on-demand delivery. As described herein, the menu items can comprise images and/or descriptive terms of food and/or drink items to be provided by the source 193 for on-demand delivery.

The network computer system 100 can include a content analyzer 110 that can parse images of the menu items from the sources 193 to determine a set of descriptive terms for each of the menu items. For example, the content analyzer 110 can perform image recognition techniques to generate a corpus representation of the menu item (e.g., on the order of tens or hundreds of descriptive words). This corpus can describe various aspects of the menu item, such as its type and origin (e.g., a full meal, side dish, salad, burger, sandwich, soup, burrito, Japanese, French, American, Mexican, Thai, Indian, etc.), its ingredients (e.g., type of meat, dressings, veggies, beans, sauces, rice, etc.), taste characteristics (e.g., spicy, mild, salty, sweet, savory, filling, heavy, light, bitter, tart, smoky, etc.), and/or texture characteristics (e.g., creamy, crunchy, greasy, crumbly, crispy, gooey, mushy, moist, rich, etc.). As provided herein, the user preferences indicated in the user preference profiles 147 stored in the user database 145 can utilize the same or similar listing of words.

In examples described herein, a particular menu item may be described by many sets of terms. Accordingly, in certain implementations, the content analyzer 110 can perform confidence links between individual terms that may be used to describe a particular menu item. Furthermore, in certain aspects, each of the descriptive terms may be represented by a vector in latent space (e.g., a graphical corpus of descriptive terms), and the average and/or factorization of the set of vectors representing the terms describing a particular menu item (e.g., in accordance with a factorization schema 122) can comprise the menu item vector or matrix representation of the menu item.

Still further, the content analyzer 110 can generate an ontological graph 173 that connects semantic aspects of menu items, such as cuisine type, country of origin, food subclass or category (e.g., rice noodles). The ontological graph 173 can further connect restaurants with semantic aspects of the menu items, and can incorporate and consolidate data sets from multiple sources, such as historical data from the on-demand delivery service, individual restaurants, and the like. In still further aspects, the content analyzer 110 can implement internationalization aspects to parse descriptive terms from multiple languages, enabling multi-language searching and localized searching in various international locations. Furthermore, the ontological graph 173 can also connect international descriptive terms with English words, which may then be represented by the same or similar vectors.

According to various examples, the ontological graph 173 can show relationships or connections between descriptive terms in the corpus representations of all comestible items in a given menu (e.g., a menu of available food items offered by multiple food item sources 193 in connection with the on-demand delivery service). Such relationships or connections can describe, for example, whether one descriptive term is a category, subclass, or other related aspect of another descriptive term. Furthermore, all descriptive terms of all possible comestible items can be organized graphically, with each descriptive term comprising a point in the ontological graph 173. Accordingly, each offered menu item can correspond to the menu item vector or matrix representation in latent space (e.g., in the corpus graph of the descriptive terms, and/or the ontological graph 173).

The network computer system 100 can further include a user device interface 125 that connects with user devices 195 executing an on-demand delivery application 196. Requesting users 197 can select from a menu of listed food items for on-demand delivery via a user interface of the delivery service application 196. According to various examples, the network computer system 100 can include a profiling engine 140 that stores and analyzes historical user data, behavioral user data, and/or past user selections to determine the general comestible item preferences of a given user 197 (e.g., favorite specific dishes, favorite type of food, such as Japanese or Indian, and/or favorite flavors).

The profiling engine 140 can parse the general user preferences of a given user 197 into a detailed word corpus that describes the user preferences with a set of descriptive terms (e.g., the same terms used to describe menu items). Based on the word corpus describing the user preferences (e.g., which can comprise on the order of tens, hundreds, or thousands of descriptive terms), the profiling engine 140 can enable a recommendation engine 120 to generate a personal preference word vector for the given user 197 (e.g., in the latent space of the word corpus in which each descriptive term is represented as a graphical point). For example, the profiling engine 140 can generate the personal preference word vector for the given user 197 on the word corpus of descriptive menu item terms, which can indicate which offered menu items most closely match the general user preferences (e.g., via a comparison between the vector representation of the user preferences, and the vector representations of each menu item).

In certain examples, the personal preference word vector can further be context-based (e.g., based on a real-time, current location of the user, time of day, day of week, search inputs, etc.). For example, the historical data in the user preference profile 147 of the user 197 can comprise metadata indicating the time of day (e.g., lunch time or dinner time), location, time of week, weather conditions, search terms, previous meal(s), subsequent meal(s), and the like, for each given meal selection by the given user 197. Thus, based on a current time and location of the user, the profiling engine 140 may determine a real-time, contextual set of user preferences, and enable the recommendation engine 120 to generate the personal preference word vector accordingly.

The recommendation engine 120 can vectorize the corpus representing each menu item and the corpus representing the general and/or contextual user preferences. The result can comprise a set of menu item vectors or matrices representing the menu of food items and the contextual user preference vector or matrix representing the predicted item preferences of the user 197. The recommendation engine 120 can perform a matrix or vector factorization of each comestible item vector and the personal preference vector—in accordance with a factorization schema 122—to output a quantity (e.g., a match probability) for each of the comestible items in the menu. A menu item or set of menu items having the highest match probabilities can be outputted by the recommendation engine 120 as recommended items on a personalized recommendation menu displayed on the user device 195 (e.g., of individual meals or a combination of meals that are determined to go well together).

In additional implementations, the source interface 105 can receive, from the menu item sources 193 data indicating source supply of each menu item from each comestible item source 193, or more granular information, such as the necessary ingredients for making each menu item, and a current supply of each ingredient from the sources 193. These supply data from the sources 193 can be parsed as additional input by the recommendation engine 120 in providing the recommendations to the users 197. For example, in addition to matching comestible item vectors with a user preference vector to generate menu item recommendations, the recommendation engine 120 can further add multipliers or weightings to current oversupplied or undersupplied menu items based on the supply data from the sources 193. As another example, the recommendation engine 120 can add multipliers or weightings to certain menu items based on ingredient supply indicated in the supply data. In such an example, the supply data may indicate an amount of each ingredient that is needed to make an individual menu item, and the total ingredient supply of the comestible item source. For each offered menu item of each source 193, the recommendation engine 120 can determine an oversupply or undersupply multiplier based on the total ingredient supply received from the source 193. Thus, in providing recommendations to the users 197, the recommendation engine 120 can generally weight oversupplied menu items over undersupplied menu items in the listed recommendations.

As described herein, each menu item provided by the sources 193 may be associated with a price. In various implementations, the profiling engine 140 can determine a price sensitivity metric for each user preference profile 147 of the users 197 (e.g., based on historical usage data of the on-demand delivery service). The recommendation engine 120 can further utilize this price sensitivity metric in generating recommendations for each of the users 197. For example, a set of vector matches may indicate several offered menu items that match the user's taste preferences (e.g., general preferences and/or taking into account real-time contextual information from the user 197). The recommendation engine 120 may then apply a multiplier to each matched menu item based on the supply data, as described above. Additionally or alternatively, the recommendation engine 120 may then apply the user's price sensitivity weighting to each matched menu item. In certain implementations, based on historical usage data, the user profile 147 may also indicate a time sensitivity metric for the user 197 (e.g., indicating whether the user prefers low rendezvous ETAs or is insensitive to ETA). In such implementations, the recommendation engine 120 may include a time sensitivity metric weighting to each matched menu item, based on the current ETA of each menu item to the user's current location. In certain example, the network computer system 100 can further determine a food rating sensitivity metric for the user 197, and factor the rating sensitivity metric into the recommendation calculation.

As an example scenario, the recommendation engine 120 can determine that a particular user 197 is not at all price sensitive or time sensitive. In this scenario, each offered menu item will have the same price sensitivity weighting and time sensitivity weighting, and the recommendation engine 120 can provide recommendations based on the other metrics (e.g., item or ingredient supply and vector matching). As another example, the recommendation engine 120 can determine that a particular user 197 is highly price sensitive, but not time sensitive. In this scenario, each offered menu item can have a price weighting based on the offered price for that menu item and the user's price sensitivity metric. Thus, higher priced items may be weighted with a comparatively low or fractional multiplier, whereas lower priced items may be weighted with higher multipliers and therefore end up more highly recommended, regardless of ETA. As yet another example, a user 197 may have some degree of price sensitivity and some degree of time sensitivity. Based on these levels of time and price sensitivity, the recommendation engine 120 can determine a current ETA and price of each offered menu item, and apply the appropriate time sensitivity weighting and price sensitivity weighting for each item. The result can comprise of a recommended list of menu items individual to the user 197, and based on user preference vector matching, ingredient or menu item supply, ETA of the menu item to the user's current location, and price of the menu item.

Upon selection of a menu item by the user 197 (whether recommended or not), a coordination engine 150 of the network computer system can communicate with drivers of transport vehicles 194 via an executing driver application 192 and a driver device interface 115 to coordinate the on-demand delivery of the selected menu item. For example, the requesting user 197 may make a selection on a menu item and confirm purchase via the on-demand service application 196 executing on the user's computing device 195. Request data indicating the selected menu item can be transmitted to the network computer system 100 over the one or more networks 180, and can be processed by the coordination engine 150. In various examples, the menu item request can include location information indicating the current location of the user 197, or the user 197 can input a rendezvous location to meet with a delivery driver.

The coordination engine 150 can further receive location data, via the driver device interface 115, from the driver devices 191 of drivers operating throughout the delivery service region (e.g., a metropolitan area). In certain examples, each transport vehicle 194 operated by a driver may also include an inventory of menu items being offered to the requesting users 197. Thus, in coordinating the on-demand delivery service, the network computing system 100 can take into account the inventory of menu items being currently transported in each transport vehicle 194. This is distinct from traditional delivery services, in which an item is requested by a person, and then packaged and delivered by a vehicle. The on-demand service described herein, can provide for more immediate on-demand delivery by forecasting menu item demand (e.g., based on historical data), coordinating the loading of inventory (e.g., comprising menu items from the sources 193) onto the transport vehicles 194 prior to receiving requests, and in some aspects, routing the transport vehicles 194 around the given service region with inventory on-board while receiving menu item requests from the user devices 195.

For each item request received from a requesting user 197, the coordination engine 150 can determine the current locations, current routes and upcoming deliveries, and/or the current inventory of proximate transport vehicles 194 to the current location of the requesting user 197 (e.g., within four miles). The coordination engine 150 can select a most optimal transport vehicle 194 based on distance, time, inventory, and/or additional utility metrics, such as transport vehicle supply, inventory supply and menu item demand within individual localities or sub-regions of the delivery service region. The coordination engine 150 may then transmit a delivery invitation to the driver device 191 of the driver of the optimal transport vehicle 194. The driver can accept or decline the invitation. If accepted, the coordination engine 150 can provide the driver device 191 with a shortest or most optimal route to the rendezvous location with the requesting user, or can add the delivery location to a current route and delivery schedule of the driver. If declined, the coordination engine 150 can repeat the optimization process of identifying a next most optimal transport vehicle 194, and transmit another delivery invitation to the driver of that vehicle 194—and repeat the sequence, if needed, until a driver accepts the delivery invitation.

User Computing Device

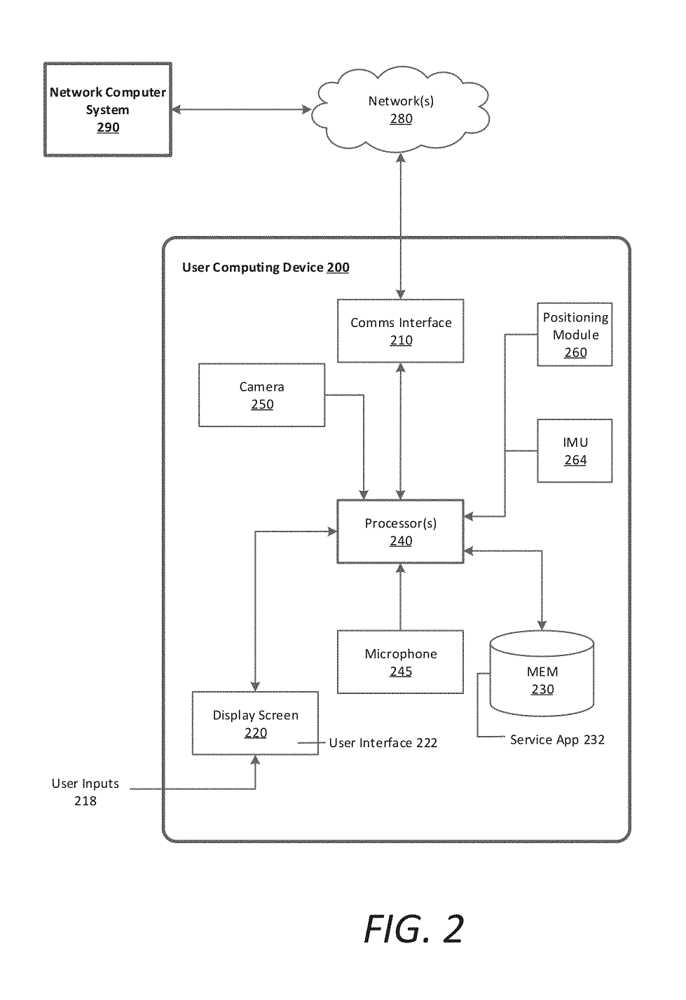

FIG. 2 is a block diagram illustrating an example user computing device executing and operating an on-demand delivery service application 232 for communicating with a network computer system, according to examples described herein. In many implementations, the user computing device 200 can comprise a mobile computing device, such as a smartphone, tablet computer, laptop computer, VR or AR headset device, and the like. As such, the user computing device 200 can include telephony features such as a microphone 245, a camera 250, and a communication interface 210 to communicate with external entities using any number of wireless communication protocols. The computing device 200 can further include a positioning module 260 and an inertial measurement unit 264 that includes one or more accelerometers, gyroscopes, or magnetometers. In certain aspects, the computing device 200 can store a designated delivery service application 232 in a local memory 230. In variations, the memory 230 can store additional applications executable by one or more processors 240 of the user computing device 200, enabling access and interaction with one or more host servers over one or more networks 280.

In response to a user input 218 by the user (e.g., the selection of an icon representing the delivery service application 232), the service application 232 can be executed by a processor 240, which can cause an application interface 222 to be generated on a display screen 220 of the computing device 200. In various implementations, the app interface 222 can enable the user to view recommended comestible items and other available menu items in a personalized food item menu on the display screen 220.

As provided herein, the service application 232 can further enable a communication link with a network computer system 290 over one or more networks 280, such as the network computer system 100 as shown and described with respect to FIG. 1. The processor 240 can generate user interface features (e.g., comestible item menu, recommended items, etc.) using content data received from the network computer system 290 over network 280. Furthermore, as discussed herein, the service application 232 can enable the network system 290 to cause the generated user interface to be displayed on the display screen 220 to include a listing of selectable menu items, as described herein.

In various examples, the positioning module 260 can provide location data indicating the current location of the user to the network system 290 to, for example, enable the network computer system 290 coordinate on-demand delivery of a selected item. In examples described herein, the network computer system 290 can transmit content data to the communication interface 210 of the user computing device 200 over the network(s) 280. The content data can cause the executing service application 232 to display a listed set of menu items available for on-demand delivery, and/or a recommended set of menu items based on the user's preferences. Upon selection of a desired menu item, the service application 232 can cause the processor 240 to transmit an item request to the network computer system 290 to enable the computer system 290 to coordinate a transport vehicle, having inventory of the selected item, to rendezvous with the user at either the user's current location, or a selected rendezvous location.

User Interfaces

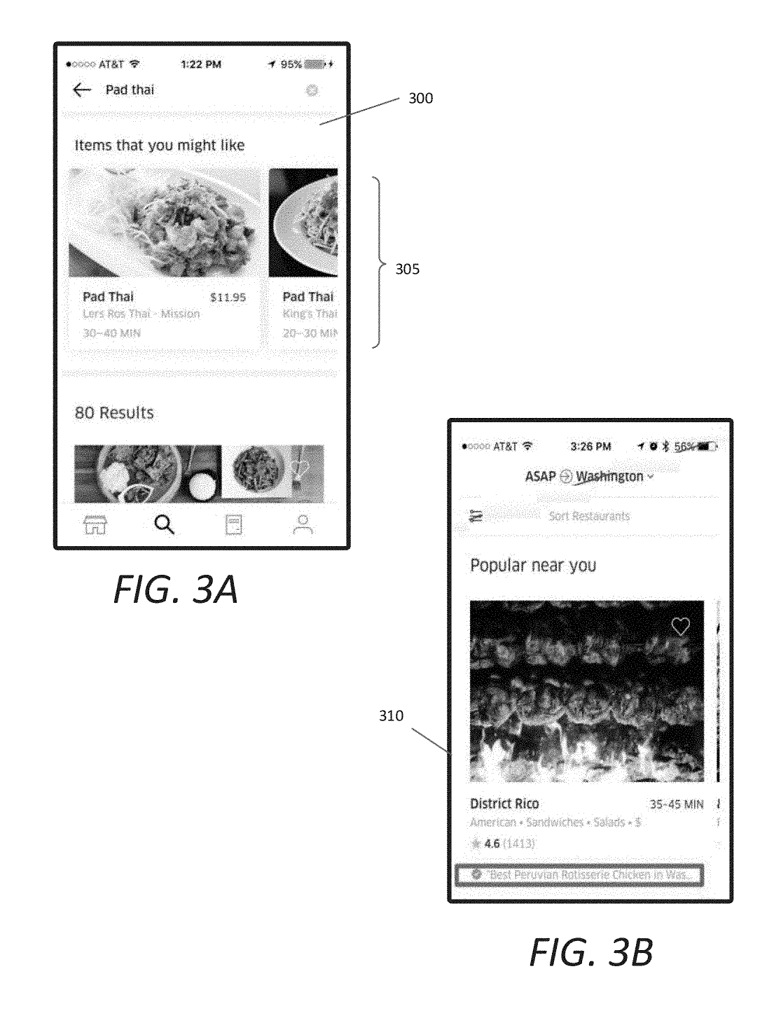

FIGS. 3A and 3B are example user interfaces showing menu item recommendations on a user computing device 200, according to examples described herein. Referring to FIG. 3A, the user interface 300 can be generated on the display screen 220 of the user computing device 200. In the example shown, the network computer system 100 has processed the user's preference profile 147, available comestible items from sources 193, item supply and/or ingredient supply, ETA of transport vehicles having each item on-board, and/or price sensitivity of the user to provide a scrollable recommendations list of menu items 305. Furthermore, the recommended list 305 may be based on an initial filter inputted by the user, such as a text search or voice input for “Pad Thai.” Accordingly, the initial filter can cause the network computer system 100 to filter out any available menu items that do not match the user's search (or similar spellings of the search), and the resultant list can be provided based on each of the recommendation metrics described herein.

Referring to FIG. 3B, the user interface 310 displayed on the user computing device 200 can also provide a general recommendation based on the preferences of other users (e.g., when historical data is lacking for the user, or upon an input by the user to provide a popular recommendation). The network computer system 100 can determine a comestible item source 193 and/or menu item from that source 193 that is widely popular (e.g., based on number of orders and/or rating), and cause the menu item to be displayed prominently on the user interface 310.

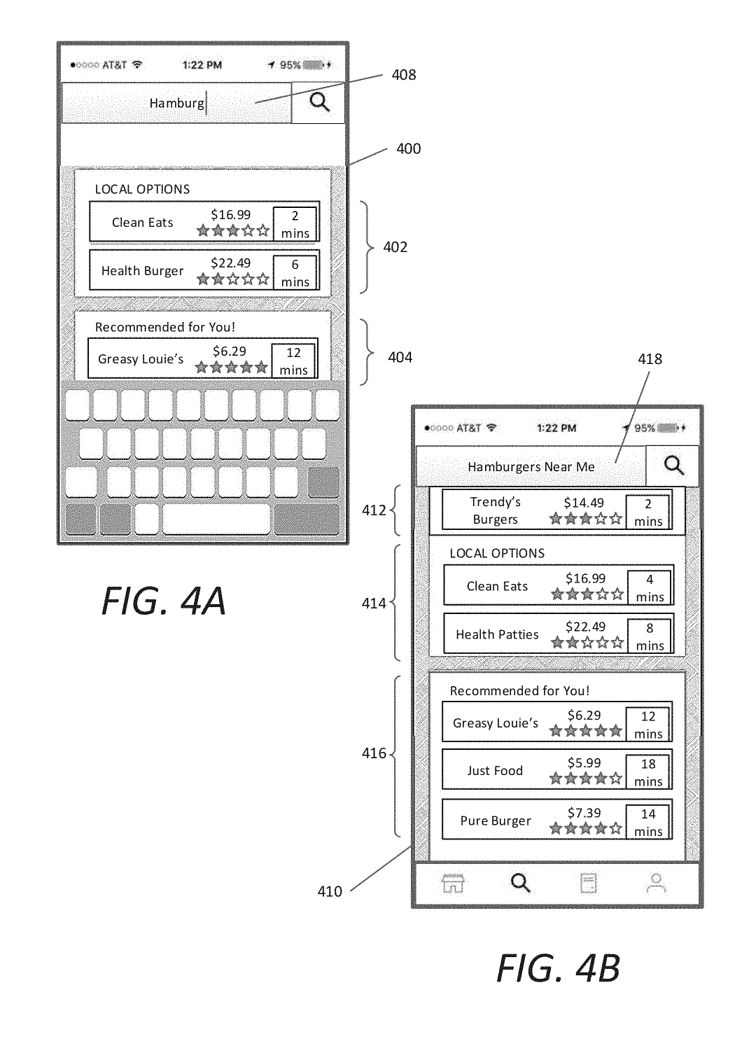

FIGS. 4A and 4B illustrate example user interfaces showing real-time and on-demand comestible item listings, according to examples described herein. Referring to FIG. 4A, a user interface 400 can be generated by the service application 232 and be displayed on the display screen 220 of a user computing device 200. In some examples, the user interface 400 can include a search feature 408, such as a text box or voice input feature, that enables a user to input search terms or voice input for comestible items. In certain variations, the user need not input any terms into the search feature, and the user interface 400 will still display a set of recommendations or matches based on the recommendation metrics described with respect to FIG. 1.

In the example shown in FIG. 4A, the network computer system 100 can provide real-time recommendations and search results based on the current location of the user, and inputs in the search feature (e.g., partial term inputs as shown in FIG. 4A). The network computing system 100 and/or service application 232 can include predictive functions to predict the search term inputted by the user into the search feature 408. Based on the predicted term(s), the network computer system 100 can, in real-time, process the recommendation metrics for the user (e.g., price sensitivity, time sensitivity, preference vector matching, etc.).

Accordingly, in real-time, the user interface 400 can display relevant matches for the user search as well as the user preferences based on the recommendation metrics. In certain aspects (e.g., if the user is highly time sensitive), the user interface can display a local offering portion 402 indicating the closest options. Each menu item can display the source, price, rating of the menu item or source (e.g., a star rating), an ETA for a nearest transport vehicle that includes the menu item in its inventory, and other information (e.g., a description of the menu item, a photo of the menu item, etc.). The local offering portion 402 can be scrollable (e.g., up to ten menu items) and can list the menu items matching the predictive search term that have the lowest ETA to the user's current location.

In various implementations, the user interface 400 can further display a recommendation interface feature 404, which can list recommended menu items based on all recommendation metrics described in connection with FIG. 1. The recommended menu items portion 404 can list most recommended items at the top, or more prominently, than lesser recommended menu items. In certain aspects, the list 404 can comprise a scrollable feature that enables the user to view and select from any number of recommended menu items (e.g., a top ten list of most recommended items).

FIG. 4B illustrates the full results of a user search in combination with the recommendations provided by the network computer system 100. The user interface 410 in FIG. 4B can be generated based, at least in part, on the search term(s) 418 inputted by the user (e.g., through text or voice). In certain aspects, the user interface 410 can be generated based on content data transmitted by the network computer system 100, and can include a most relevant result feature 412 indicating the most relevant menu item based on only the search input 418. Additionally or alternatively, the user interface 410 can include a scrollable set of local options 414 that closely match the search input 418. In certain variations, the user interface 410 can further include a recommendation portion 416, which can list a set of options based on the user's preferences (e.g., general and contextual), and other metrics, such as time sensitivity, price sensitivity, and supply data from the sources. The recommendation results shown in FIG. 4B indicate that the user is highly price sensitive and has a particular taste for highly rated hamburgers (e.g., unhealthy hamburgers).

Source Computing Device

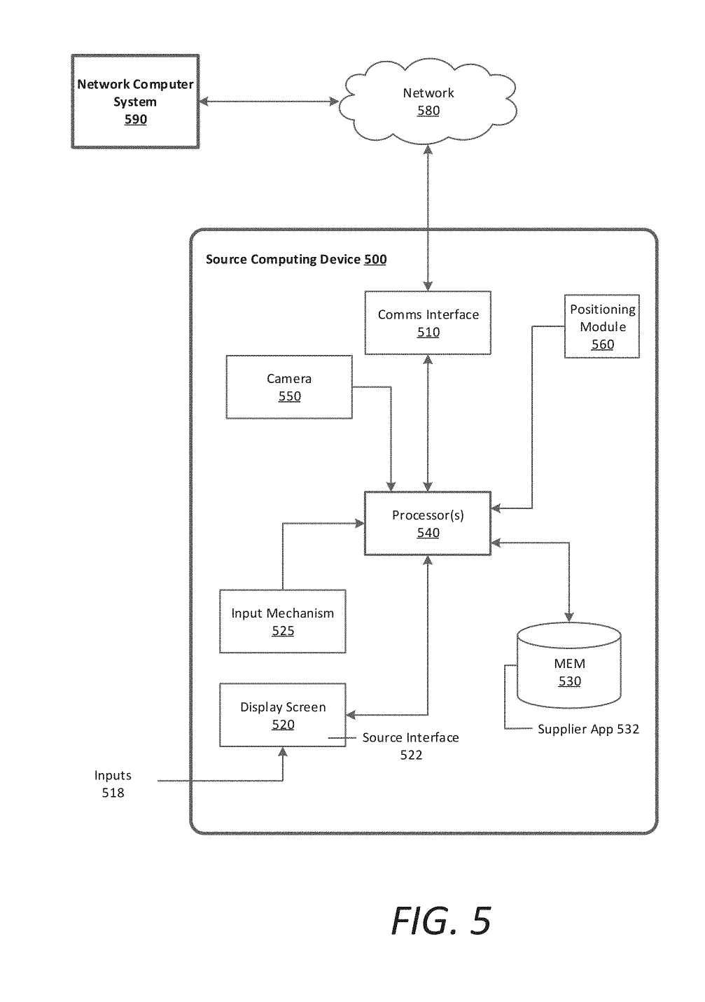

FIG. 5 is a block diagram illustrating an example source computing device executing and operating a source application for communicating with a network computer system, according to examples described herein. In many implementations, the source computing device 500 can comprise a mobile or personal computing device, such as a smartphone, tablet computer, laptop computer, desktop computer, VR or AR headset device, and the like. In certain example, the source computing device 500 can include a camera 550 (e.g., to enable a restaurant owner to take a photograph of a food item), a positioning module 560, an input mechanism 525 (e.g., a keyboard), a display screen 520, and a communication interface 510 to communicate with the network computing system 590 using any number of wireless communication protocols.

In certain aspects, the computing device 500 can store a designated supplier application 532 in a local memory 530, enabling access and interaction with one or more host servers over one or more networks 580. In response to an input 518 by a supply manager (e.g., a restaurant manager), the supplier application 532 can be executed by a processor 240, which can cause a source interface 522 to be generated on the display screen 520 of the computing device 500. In various implementations, the source interface 522 can enable the supply manager to communicate offered menu items from the source to the network computer system 590.

As provided herein, the source computing device 500 can also enable the supply manager to provide supply data indicating menu item supply and/or ingredient supply from the source (e.g., a restaurant participating in the on-demand delivery service). In certain examples, the network computing system 590 can link directly with a supply management feature of the source to determine the supply of each offered menu item, and/or the supply of each ingredient utilized by the source to make each menu item.

In various examples, the network computer system 590 can transmit supply requests to the source computing device 500 for quantities of menu items, or the supply manager can communicate a supply quantity for each offered menu item. The network computer system 590 may then coordinate the pick-up and distribution of menu items from the source by transport vehicles providing the on-demand delivery service.

Example Source Interfaces

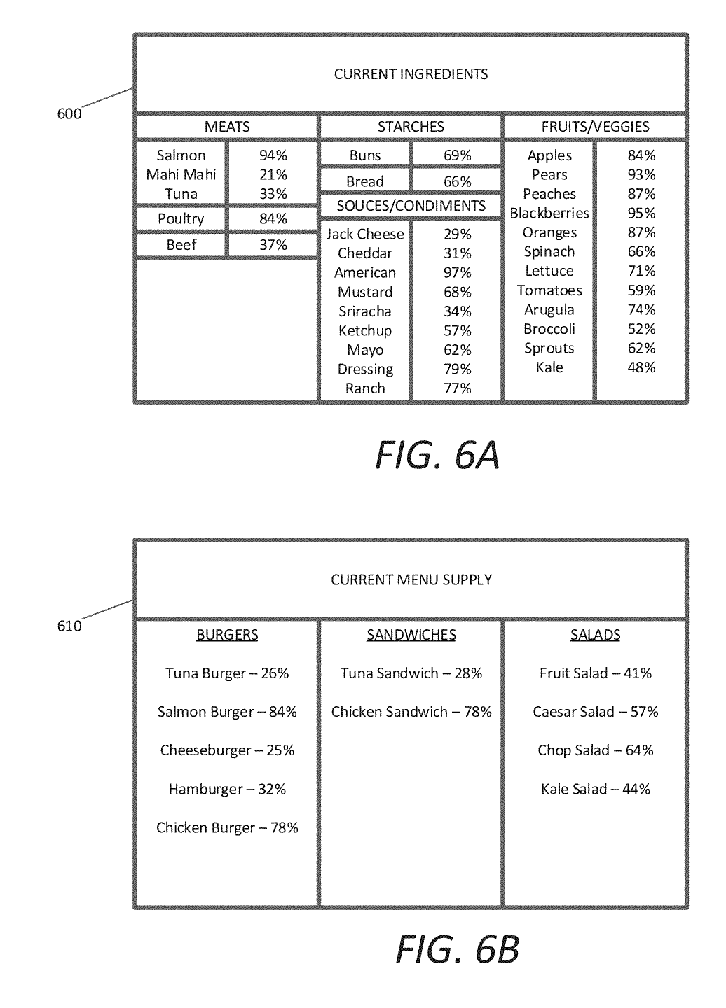

FIGS. 6A and 6B illustrate example source interfaces for food item sources, according to examples described herein. In certain implementations, a menu item source (e.g., a restaurant) can transmit real time ingredient supply data or menu item supply data to the network computer system 100. Referring to FIG. 6A, a source interface 600 can be accessed by the network computer system 100 to determine current ingredient supply as an input for generating recommendations to users. In certain implementations, the network computer system 100 can weight recommendations of menu items from a given source based on the current supply of ingredients available to each source. Referring to FIG. 6B, the network computer system 100 can access a source interface 610 indicating supply data of individual menu items of a given source in order to weight recommendations to users of the on-demand delivery service. In some examples, the supply data shown in source interfaces 600, 610 can be transmitted to the network computer system 100 periodically, or can be dynamically monitored by the network computer system 100.

Methodology

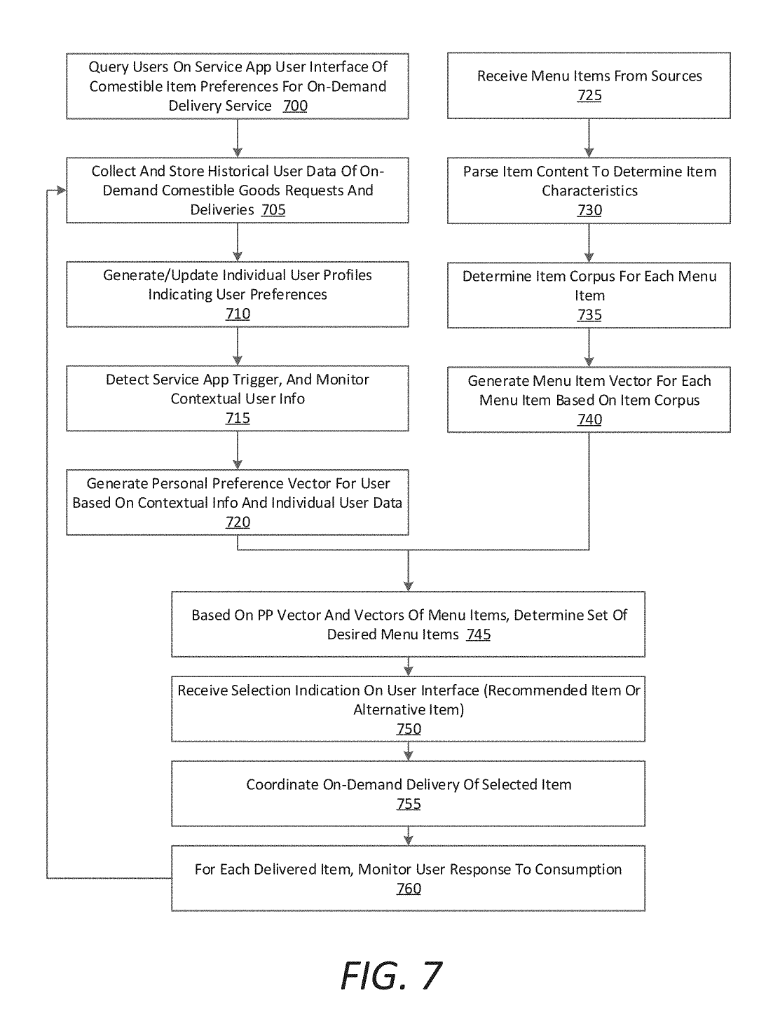

FIG. 7 is a flow chart describing an example method of coordinating food item delivery based on generated item recommendations for users of an on-demand item delivery service, according to various examples. In the below description of FIG. 7, reference may be made to reference characters representing various features of FIGS. 1 through 6B. Furthermore, the processes described with respect to FIG. 7 may be performed by an example network computer system 100 as shown and described with respect to FIG. 1.

Referring to FIG. 7, in certain examples, the network computer system 100 can query users directly on the user interface 222 of the service application 196 of their comestible item preferences for the on-demand delivery service (700). In various implementations, the network computer system 100 can further collect and store historical user data corresponding to on-demand comestible goods requests and deliveries for each user 197 (705). The network computer system 100 can further generate and update individual user profiles 147 indicating user preferences of comestible items (710). For example, the network computer system 100 can determine the general comestible item preferences of the user 197 (e.g., whether the user typically orders a certain type of meal, such as a Caesar salad). In further examples, the network computer system 100 can further include contextual information for each order made by the user 197, such as the time of day, day of the week, weather conditions, search terms, etc. Accordingly, the user profile 147 can further include user preferences in view of contextual information (e.g., a user's preference for American food at lunchtime).

According to examples described herein, the network computer system 100 can detect a service application trigger from a user computing device 195, indicating the user 197 launching the service application 196 on the user's computing device 195. In certain implementations, the network computer system 100 or the executing service application 196 can monitor the user's interactions on the service application 196, such as eye gaze, scrolling, user inputs, and the location of the user (710). In certain aspects, the network computer system 100 can further determine the current time, weather conditions, and other real-time contextual information of the user. Based on the user's preference profile 147, indicating contextual and/or general comestible item preferences, the network computer system can generate a personal preference vector for the user 197 (e.g., in latent space comprising a corpus of descriptive terms for comestible goods) (720).

In various implementations, the network computer system 100 can receive offered menu items from various comestible goods sources (e.g., restaurants) in a delivery service region (725). For example, the sources can provide the network computer system 100 with menu listings, images, descriptions, an amount of supply, offered prices, etc., for each menu item. The network computer system 100 can parse item content for each menu item to determine the characteristics of the item (730). For example, the network computer system 100 can determine the flavor(s), consistency, origin, ingredients, calorie count, popularity, rating, and the like, of each menu item. The network computer system 100 may then generate an item corpus comprising a detailed word representation of the menu item (735), and generate a menu item vector (e.g., a word vector) for the menu item (e.g., in latent space comprising the corpus of descriptive terms for comestible goods) (740).

Based on the personal preference vector and the descriptive vector of each menu item, the network computer system 100 can determine a set of matching menu items for the user (745). For example, the network computer system 100 can perform Bayesian statistical inference to identify the set of matching menu items, or to determine a set of menu items that have a highest probability of satisfying the user's preferences. The network computer system 100 and/or the service application 196 executing on the user's computing device 195 may then display the matching set of menu items on a recommendation portion of the user interface 222. The network computer system 100 can receive, over one or more networks 180, a selection indication indicating that the user 197 has selected a menu item on the user interface 222 (750). The network computer system 100 may then coordinate on-demand delivery of the selected menu item, as described herein (755). In various implementations, the network computer system 100 can monitor user response to consumption of the delivered menu item (760). For example, for delivered menu items to the user 197, the network computer system 100 can receive satisfaction feedback from the user 1997, such as a satisfaction rating or score. Such ratings or scores may then be factored into the user's preference profile 147 for future recommendations.

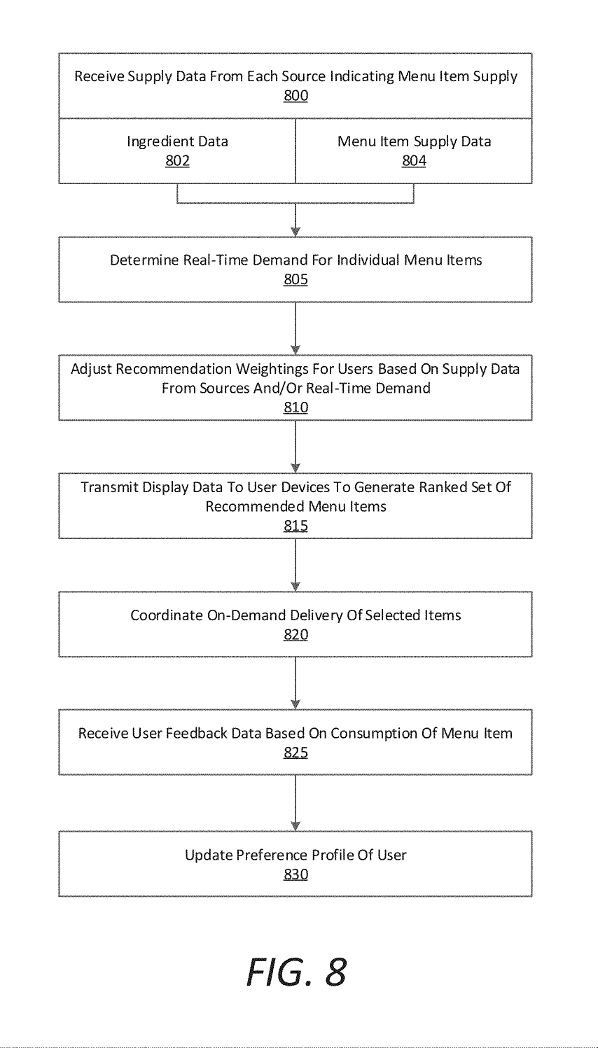

FIG. 8 is a flow chart describing a method of coordinating menu item delivery using multi-entity optimization, according to various examples. In various examples, the below steps discussed with respect to FIG. 8 may be performed in connection with one or more steps described in connection with FIG. 7. Referring to FIG. 8, the network computer system 100 can receive supply data from each source 193 indicating menu items supply (800). In certain examples, the supply data can comprise ingredient supply data (802). Additionally or alternatively, the supply data can comprise menu item supply data (804). The network computer system 100 can further determine real-time demand for individual menu items (805). For example, the network computer system 100 can receive item requests from users 197 throughout a delivery service region to determine the real-time demand.

In various examples, the network computer system 100 can adjust recommendation weightings for users 197 based on the supply data received from the sources 193 and/or the real-time demand from the users 197 (810). For example, the network computer system 100 can cause oversupplied menu items to be displayed more prominently or ranked higher in a recommendation list on the computing devices 195 of the users 197. Based on the real-time, adjusted weightings of the recommendation metrics for each user 197, the network computer system 100 can transmit display data to the user computing devices 195 to cause the user computing devices 195 to generate and display the ranked set of recommended menu items (815). Based on received selection data from the computing devices 195 of the users 197, the network computing system 100 can coordinate on-demand delivery of the selected items, as described herein (820).

For each delivered item to each user 197, the network computer system 100 can determine a user response to consumption of the menu item (825). For example, the network computer system 100 can receive feedback data indicating a rating or textual information. Based on the feedback data, the network computer system 100 can update the user's preference profile 147 for future recommendations (830). For example, the updated preference profile 147 can comprise adjusted weightings for recommendation metrics individual to the user 197. Additionally, the adjusted weightings can result in an updated personal preference vector for the user 197 for determining future menu item recommendations.

Hardware Diagram

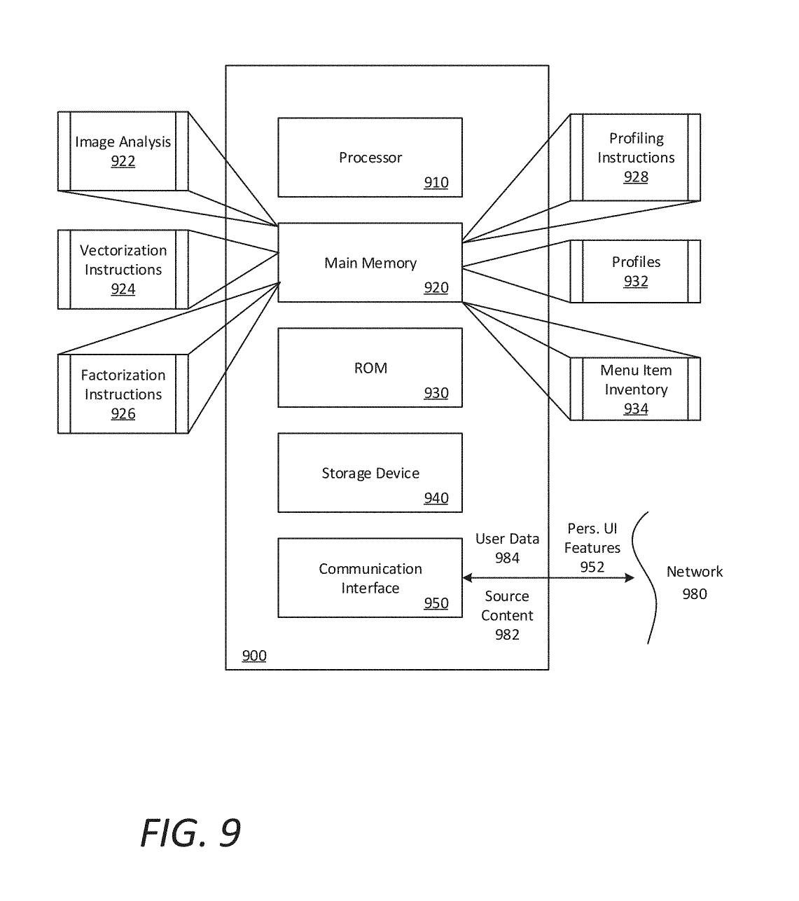

FIG. 9 is a block diagram that illustrates a computer system upon which examples described herein may be implemented. A computer system 900 can be implemented on, for example, a server or combination of servers. For example, the computer system 900 may be implemented as part of a network service, such as described in FIGS. 1 through 8. In the context of FIG. 1, the computer system 100 may be implemented using a computer system 900 such as described by FIG. 9. The computer system 100 may also be implemented using a combination of multiple computer systems as described in connection with FIG. 9.

In one implementation, the computer system 900 includes processing resources 910, a main memory 920, a read-only memory (ROM) 930, a storage device 940, and a communication interface 950. The computer system 900 includes at least one processor 910 for processing information stored in the main memory 920, such as provided by a random access memory (RAM) or other dynamic storage device, for storing information and instructions which are executable by the processor 910. The main memory 920 also may be used for storing temporary variables or other intermediate information during execution of instructions to be executed by the processor 910. The computer system 900 may also include the ROM 930 or other static storage device for storing static information and instructions for the processor 910. A storage device 940, such as a magnetic disk or optical disk, is provided for storing information and instructions.

The communication interface 950 enables the computer system 900 to communicate with one or more networks 980 (e.g., cellular network) through use of the network link (wireless or wired). Using the network link, the computer system 900 can communicate with one or more computing devices, one or more servers, one or more databases, and/or one or more self-driving vehicles. In accordance with examples, the computer system 900 receives requests from mobile computing devices of individual users. The executable instructions stored in the memory 930 can include image analysis instructions 922, vectorization instructions 924, factorization instructions 926, profiling instructions 928, user preference profiles 932, and a real-time menu item inventory 934.

By way of example, the instructions and data stored in the memory 920 can be executed by the processor 910 to implement the functions of an example computer system 100 of FIG. 1. In various examples, the processor 910 can execute the image analysis instructions 922 to parse source content 982 of menu items into a corpus of descriptive terms. In certain implementations, the processor 910 execute the vectorization instructions 924 to generate vector or matrix representations of menu items and/or personal user preferences in latent space (e.g., in a graphical representation of a word corpus of all descriptive terms). Execution of the factorization instructions 926 can cause the processor 910 to factorize the personal preference and menu item vectors or matrices to output a set of recommended menu items for the user 197 (e.g., as personalized user interface features 952 displayed on the user's computing device 195). The processor 910 can execute the profiling instructions 928 to parse historical user data 984 to generate a preference profile 932 for the user 197, which the processor 910 can access to apply recommendation weightings and/or generate the personal preference vector for the user 197. In various implementations, the memory 920 can further store and dynamically update a live menu-item inventory 934 based on supply data received from the sources 193, which the processor 910 can utilize to apply weightings to the recommendation metrics, as described herein.

Examples described herein are related to the use of the computer system 900 for implementing the techniques described herein. According to one example, those techniques are performed by the computer system 900 in response to the processor 910 executing one or more sequences of one or more instructions contained in the main memory 920. Such instructions may be read into the main memory 920 from another machine-readable medium, such as the storage device 940. Execution of the sequences of instructions contained in the main memory 920 causes the processor 910 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A network computer system implementing an on-demand delivery service, comprising:
a network communication interface connecting, over one or more networks, with (i) computing devices of users of the on-demand delivery service, (ii) computing devices of menu item sources of the on-demand delivery service, and (iii) computing devices of transport vehicles of the on-demand delivery service;
one or more processors; and
one or more memory resources storing instructions that, when executed by the one or more processors, cause the network computer system to:
for each respective user of the on-demand delivery service, generate a preference profile indicating a set of user preferences for comestible items;
receive, over the one or more networks, a set of available menu items from the menu item sources;
for each available menu item, generate a menu item vector in latent space comprising a word corpus of descriptive terms, the menu item vector representing the available menu item;
for the respective user, generate a personal preference vector in the latent space, the personal preference vector representing the set of user preferences in the preference profile of the respective user;
based on the menu item vector of each available menu item and the personal preference vector of the respective user, determine a set of matching menu items from the set of available menu items;
transmit, over the one or more networks, content data to the computing device of the respective user, causing the computing device to display the set of matching menu items as selectable items for on-demand delivery;
receive, over the one or more networks, selection data from the computing device of the respective user, the selection data indicating a user selection of one of the available menu items; and
in response to receiving the selection data, coordinate, through network communications with one or more of the transport vehicles, on-demand delivery of the selected menu item to the respective user.

2. The network computer system of claim 1, wherein the executed instructions further cause the network computer system to:
determine present contextual information of the respective user;
wherein the executed instructions cause the network computer system to further determine the set of matching menu items based on the present contextual information.

3. The network computer system of claim 2, wherein the present contextual information indicates at least one of at time of day, a day of week, weather conditions, a current location of the respective user, or search inputs by the respective user.

4. The network computer system of claim 1, wherein the executed instructions further cause the network computer system to:
collect historical data of the respective user in connection with the on-demand delivery service;
wherein the preference profile of the respective user is based on the historical data.

5. The network computer system of claim 4, wherein the executed instructions further cause the network computer system to:
based on the historical data of the respective user, determine a price sensitivity metric for the respective user;
wherein the executed instructions cause the network computer system to further determine the set of matching menu items based on the price sensitivity metric for the respective user.

6. The network computer system of claim 4, wherein the executed instructions further cause the network computer system to:
based on the historical data of the respective user, determine a time sensitivity metric for the respective user;
wherein the executed instructions cause the network computer system to further determine the set of matching menu items based on the time sensitivity metric for the respective user.

7. The network computer system of claim 1, wherein the executed instructions further cause the network computer system to:
receive, over the one or more networks, supply data from each menu item source, the supply data indicating at least one of a supply of available menu items provided by the menu item source, or a supply of ingredients comprising the available menu items provided by the menu item source.

8. The network computer system of claim 7, wherein the executed instructions cause the network computer system to determine the set of matching menu items by weighting a set of recommendation metrics for the respective user based on the supply data.

9. The network computer system of claim 1, wherein the executed instructions cause the network computer system to coordinate on-demand delivery of the selected menu item to the respective user by:
receiving, over the one or more networks, (i) location data indicated current locations of each transport vehicle, and (ii) inventory data indicating an inventory of available menu items being transported by each transport vehicle; and
based at least in part on the location data and the inventory data, select an optimal transport vehicle to deliver the selected menu item to the respective user.

10. The network computer system of claim 9, wherein the executed instructions further cause the network computer system to:
transmit, over the one or more networks, a delivery invitation to a computing device of the optimal transport vehicle, wherein the delivery invitation enables a driver of the optimal transport vehicle to accept or decline delivery of the selected menu item to the respective user.

11. The network computer system of claim 1, wherein the word corpus is comprised in an ontological graph indicating relationships between the descriptive terms of the word corpus.

12. The network computer system of claim 1, wherein each available menu item of the received set of available menu items comprises an image of the menu item, and wherein the executed instructions further cause the network computer system to:
parse, using image recognition, the image of the available menu item to generate a word description of the available menu item;
wherein the executed instructions cause the network computer system to generate the menu item vector for the available menu item based on the word description of the available menu item as parsed from the image.

13. A non-transitory computer readable medium storing instructions that, when executed by one or more processors, cause the one or more processors to:
for each respective user of an on-demand delivery service, generate a preference profile indicating a set of user preferences for comestible items;
receive, over the one or more networks, a set of available menu items from a plurality of menu item sources;
for each available menu item, generate a menu item vector in latent space comprising a word corpus of descriptive terms, the menu item vector representing the available menu item;
for the respective user, generate a personal preference vector in the latent space, the personal preference vector representing the set of user preferences in the preference profile of the respective user;
based on the menu item vector of each available menu item and the personal preference vector of the respective user, determine a set of matching menu items from the set of available menu items;
transmit, over one or more networks, content data to a computing device of the respective user, causing the computing device to display the set of matching menu items as selectable items for on-demand delivery;
receive, over the one or more networks, selection data from the computing device of the respective user, the selection data indicating a user selection of one of the available menu items; and
in response to receiving the selection data, coordinate, through network communications with one or more transport vehicles, on-demand delivery of the selected menu item to the respective user.

14. The non-transitory computer readable medium of claim 13, wherein the executed instructions further cause the network computer system to:
determine present contextual information of the respective user;
wherein the executed instructions cause the one or more processors to further determine the set of matching menu items based on the present contextual information.

15. The non-transitory computer readable medium of claim 14, wherein the present contextual information indicates at least one of at time of day, a day of week, weather conditions, a current location of the respective user, or search inputs by the respective user.

16. The non-transitory computer readable medium of claim 13, wherein the executed instructions further cause the one or more processors to:
collect historical data of the respective user in connection with the on-demand delivery service;
wherein the preference profile of the respective user is based on the historical data.

17. The non-transitory computer readable medium of claim 16, wherein the executed instructions further cause the one or more processors to:
based on the historical data of the respective user, determine a price sensitivity metric for the respective user;
wherein the executed instructions cause the one or more processors to further determine the set of matching menu items based on the price sensitivity metric for the respective user.

18. The non-transitory computer readable medium of claim 16 wherein the executed instructions further cause the one or more processors to:
based on the historical data of the respective user, determine a time sensitivity metric for the respective user;
wherein the executed instructions cause the one or more processors to further determine the set of matching menu items based on the time sensitivity metric for the respective user.

19. The non-transitory computer readable medium of claim 13, wherein the executed instructions further cause the one or more processors to:
receive, over the one or more networks, supply data from each menu item source, the supply data indicating at least one of a supply of available menu items provided by the menu item source, or a supply of ingredients comprising the available menu items provided by the menu item source.

20. A computer-implemented method of implementing an on-demand delivery service, the method being performed by one or more processors and comprising:
for each respective user of the on-demand delivery service, generating a preference profile indicating a set of user preferences for comestible items;
receiving, over the one or more networks, a set of available menu items from a plurality of menu item sources;
for each available menu item, generating a menu item vector in latent space comprising a word corpus of descriptive terms, the menu item vector representing the available menu item;
for the respective user, generating a personal preference vector in the latent space, the personal preference vector representing the set of user preferences in the preference profile of the respective user;
based on the menu item vector of each available menu item and the personal preference vector of the respective user, determining a set of matching menu items from the set of available menu items;
transmitting, over one or more networks, content data to a computing device of the respective user, causing the computing device to display the set of matching menu items as selectable items for on-demand delivery;
receiving, over the one or more networks, selection data from the computing device of the respective user, the selection data indicating a user selection of one of the available menu items; and
in response to receiving the selection data, coordinating, through network communications with one or more transport vehicles, on-demand delivery of the selected menu item to the respective user.
